(19) United States
(12) Patent Application Publication
(10) Pub. No.: US 2022/0393312 A1
(43) Pub. Date: Dec. 8, 2022

(54) TERMINAL FASTENERS FOR TRACTION BATTERIES

(71) Applicant: JAGUAR LAND ROVER LIMITED, Whitley, Coventry, Warwickshire (GB)

(72) Inventor: Adam Matthew BERGIN, Whitley, Conventry, Warwickshire (GB)

(21) Appl. No.: 17/755,667

(22) PCT Filed: Nov. 3, 2020
(86) PCT No.: PCT/EP2020/080776

§ 371 Date: May 4, 2022

(30) Foreign Application Priority Data
Nov. 4, 2019 (GB) 1916024.1

(51) Int. Cl. H01M 50/517; H01R 4/56; H01R 4/30; H01R 4/70; H01M 50/296; H01M 50/249; H01M 50/204

(52) U.S. Cl. CPC H01M 50/517; H01R 4/56; H01R 4/308; H01R 4/70; H01M 50/296; H01M 50/249; H01M 50/204; H01R 2201/26; H01M 2220/20

(57) ABSTRACT

Aspects of the present disclosure relate to a terminal fastener for electrically connecting a battery terminal associated with at least part of a traction battery to an electrical circuit of a vehicle, the terminal fastener comprising: a terminal engaging portion configured to engage with the battery terminal; a tool receiving portion configured to receive a tool to fasten the terminal engaging portion to the battery terminal; and insulation configured to cover at least part of the terminal fastener.

### TECHNICAL FIELD

The present disclosure relates to terminal fasteners for traction batteries. In particular, but not exclusively it relates to a terminal fastener for electrically connecting a battery terminal associated with at least part of a traction battery to an electrical circuit of a vehicle.

### BACKGROUND

Electric vehicles and hybrid electric vehicles comprise traction batteries. Traction batteries comprise a plurality of battery cells.

During assembly, the battery cells need to be electrically connected in series and electrically connected to an electrical circuit of the vehicle.

A terminal fastener may be used to fasten a battery terminal to a portion of an electrical circuit. An example of a terminal fastener is a threaded nut, configured to engage with threads on a threaded battery terminal.

Individual battery cells may be supplied for assembly with a partially-depleted and not fully-depleted state of charge, for durability reasons. The process of assembling the battery cells into packs may be slowed by accounting for the voltages that may be encountered.

### SUMMARY

It is an aim of the present disclosure to address one or more of the disadvantages associated with the prior art.

Aspects and embodiments of the disclosure provide a terminal fastener, a system, a traction battery, a vehicle, and a method.

According to an aspect of the disclosure there is provided a terminal fastener for electrically connecting a battery terminal associated with at least part of a traction battery to an electrical circuit of a vehicle, the terminal fastener comprising: a terminal engaging portion configured to engage with the battery terminal; a tool receiving portion configured to receive a tool to fasten the terminal engaging portion to the battery terminal; and insulation configured to cover at least part of the terminal fastener. An aspect of the tool receiving portion and insulation is improved touch-proofing of the terminal fastener during assembly.

In some examples, the insulation has freedom of rotation relative to at least the terminal engaging portion. An aspect is improved ease of assembly, should the insulation be required to face a specific orientation. For example, the insulation may be axi-asymmetric.

In some examples, the insulation is a captive component of the terminal fastener. One aspect is improved ease of assembly.

In some examples, the terminal engaging portion and the tool receiving portion are fixed to each other. One aspect of the disclosure is improved ease of assembly with reduced touching by the human body, because the terminal engaging portion does not need to be separately held in position during fastening.

In some examples, the tool receiving portion comprises electrically conductive material, the terminal engaging portion comprises electrically conductive material, and the tool receiving portion is electrically coupled to the terminal engaging portion. In some examples, the insulation comprises a first aperture for at least the terminal engaging portion and a second aperture for the tool receiving portion. An aspect is improved ease of assembly with reduced touching by the human body, because the aperture in the insulation for the tool receiving portion may be dimensioned to receive a tool head but not a human body part such as a finger.

In some examples, the terminal fastener comprises an interface component, such as a washer, configured to mechanically interface with a component, such as a busbar, of the electrical circuit of the vehicle. In some examples, the interface component is configured to electrically couple the terminal engaging portion to the component of the electrical circuit of the vehicle. An aspect is improved ease of assembly to provide a secure electrical connection, with reduced touching by the human body.

In some examples, the interface component has freedom of rotation relative to at least the terminal engaging portion. An aspect is improved ease of assembly with reduced chance of damaging a busbar or other object in contact with the interface component.

In some examples, the interface component is a captive component of the terminal fastener. An aspect is improved ease of assembly and protection of the busbar.

In some examples, the interface component comprises an aperture for enabling the terminal engaging portion and the battery terminal to access each other. An aspect is improved ease of assembly, because fastening the terminal engaging portion to the battery terminal compresses the interface component against the component of the electrical circuit of the vehicle.

In some examples, a width of the insulation decreases with decreasing distance from the terminal engaging portion. In some examples, at least a portion of an exterior surface of the insulation is flexible. An aspect is improved touch-proofing with less of a penalty to ease of assembly, because the narrowing and flexibility creates more space for component(s) of the electrical circuit to follow highly three-dimensional paths.

In some examples, the terminal engaging portion is threaded. This enables fast assembly and potential disassembly.

According to an aspect of the disclosure there is provided a system comprising a terminal fastener as described herein, and a cell module, wherein the cell module is configured to house a plurality of battery cells, and comprises the battery terminal. An example of a modular construction is that traction batteries of various shapes can be provided within a vehicle.

In some examples, the system comprises a busbar, wherein the terminal fastener is configured to electrically connect the battery terminal to the electrical circuit of the vehicle by mechanically fixing and electrically connecting the busbar to at least a portion of the battery terminal. An aspect of a busbar is lower electrical resistance than a wire.

In some examples, the terminal fastener is configured to compress the busbar against electrically conductive material to form an electrical connection.

In some examples, the busbar comprises an aperture to facilitate fixing of the busbar in position by the engagement of the terminal engaging portion with the battery terminal.

In some examples, the system comprises the plurality of battery cells housed by the cell module.

According to an aspect of the disclosure there is provided a traction battery comprising a plurality of cell modules and one or more busbars, wherein the cell modules are electrically interconnected by the busbars.

According to an aspect of the disclosure there is provided a vehicle comprising the traction battery.

According to an aspect of the disclosure there is provided a method of manufacture of a traction battery of a vehicle, using the terminal fastener as described herein, the method comprising: positioning a busbar against a battery terminal associated with at least part of the traction battery; positioning the terminal fastener against the busbar; engaging the terminal engaging portion of the terminal fastener with the battery terminal, with the busbar therebetween; engaging a tool with the tool receiving portion of the terminal fastener; and using the tool to fasten the terminal engaging portion of the terminal fastener to the battery terminal, causing the terminal fastener to compress the busbar against electrically conductive material to form an electrical connection.

Within the scope of this application it is expressly intended that the various aspects, embodiments, examples and alternatives set out in the preceding paragraphs, or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 illustrates an example of a vehicle;

FIG. 2 illustrates an example of a system comprising a cell module;

FIG. 3 illustrates an example of an end cap for a cell module for a traction battery;

FIG. 4 illustrates an example of a terminal fastener;

FIG. 5 illustrates an example geometry for insulation of a terminal fastener;

FIG. 6 illustrates an example of a system comprising a cell module and a terminal fastener and a busbar;

FIG. 7 illustrates an example of a system comprising cell modules, terminal fasteners, and busbars;

FIG. 8 illustrates an example geometry for insulation of a terminal fastener; and

FIG. 9 illustrates an example of a method.

### DETAILED DESCRIPTION

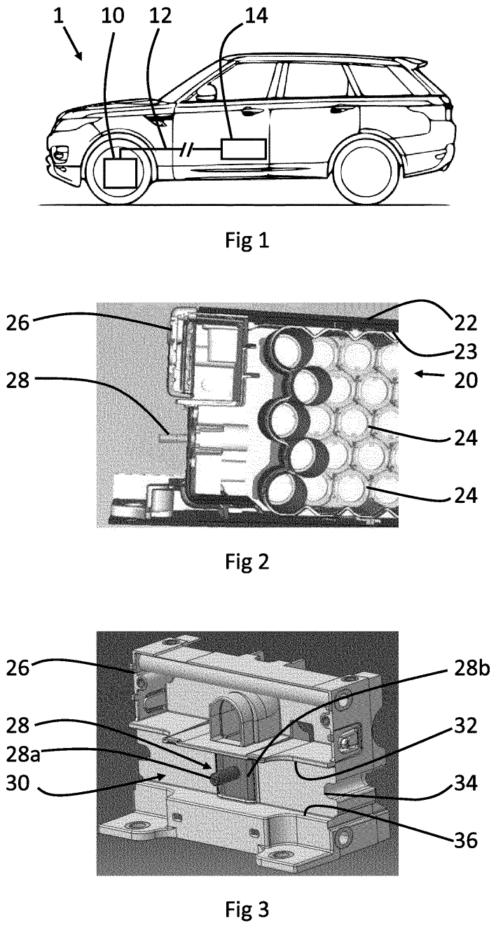

FIG. 1 illustrates an example of a road vehicle 1 (‘vehicle’ herein) in which embodiments of the disclosure can be implemented. In some, but not necessarily all examples, the vehicle 1 is a passenger vehicle, also referred to as a passenger car or as an automobile. In other examples, embodiments of the disclosure can be implemented for other applications.

The vehicle 1 may be an electric vehicle (EV) or a hybrid electric vehicle (HEV), comprising an electric torque source. An EV lacks an internal combustion engine (ICE), while an HEV additionally comprises an ICE.

An EV or HEV as shown in FIG. 1 comprises at least one traction battery 14, at least one electric traction motor 10, and an electrical circuit 12 configured to transfer electrical energy between one or more traction batteries and one or more electric traction motors. Associated components such as inverters are omitted for clarity.

FIG. 2 illustrates a system 20 for a traction battery 14. The system 20 comprises one or more cell modules 22, shown in cutaway.

The cell module 22 comprises a plurality of battery cells 24, such as more than ten or more than a hundred battery cells 24.

The cell module 22 may comprise a housing 23 that houses the plurality of battery cells 24. The housing 23 may comprise an internal cavity comprising the plurality of battery cells 24.

The illustrated battery cells 24 are packed in a hexagonal honeycomb structure. However, various different cell shapes (e.g. circular cylinders, cuboids) and different packing arrangements are possible, depending on implementation.

A traction battery 14 may comprise a plurality of cell modules 22, or alternatively the traction battery 14 may directly house the battery cells 24 without a plurality of individual cell modules 22.

In FIG. 2, but not necessarily in all examples, the cell module 22 comprises an end cap 26. The end cap 26 may be either integrally formed with the housing 23 or may be a separate component fixed to the housing 23 when all battery cells 24 have been added.

The illustrated system 20 also comprises a battery terminal 28 configured to electrically connect the battery cell(s) 24 to the electrical circuit 12 of the vehicle 1. Just one battery terminal 28 is shown. In some examples, the system 20 comprises at least two battery terminals 28 of opposite polarities, to enable a closed electrical circuit. Each cell module 22 may comprise a pair of opposite-polarity battery terminals 28.

The illustrated battery terminal 28 is male, defining a plug. In other examples, the battery terminal 28 may be female, defining a socket.

In FIG. 2, but not necessarily in all examples, the cell module 22 comprises the battery terminals 28. The terminal voltage between the battery terminals 28 of a cell module 22 may be the series sum of the voltages of the individual serially electrically interconnected battery cells 24 of the cell module 22. In some examples, a cell module 22 may comprise one or more parallel strings of battery cells 24 to control electrical capacity.

A plurality of cell modules 22 may be electrically interconnected in series and/or in parallel to provide the final nominal voltage of the traction battery 14.

FIG. 3 shows an example of an end cap 26 for a cell module 22 such as the cell module 22 shown in FIG. 2. In this example, the end cap 26 comprises the battery terminal 28.

The battery terminal 28 in FIG. 3 resides in a desired location for connecting the cell module 22 to one or more components, such as busbars (not shown) of the electrical circuit 12 of the vehicle 1. In FIG. 3, the end cap 26 comprises a guide channel 30 for locating the component(s) of the electrical circuit 12 of the vehicle 1 in the desired location.

The illustrated guide channel 30 comprises a first channel wall 32, a second channel wall 36, and a channel floor 34 extending between the first and second channel walls 32, 36. The guide channel 30 may be dimensioned to receive the electrical circuit component such as a busbar(s) between the first and second channel walls 32, 36.

The first and second channel walls 32, 36 of the guide channel 30 may have a depth configured to inhibit translation of the electrical circuit component in at least one axis once that component has been inserted into the guide channel 30 between the first and second channel walls 32, 36.

In FIG. 3, the battery terminal 28 is configured to electrically connect with the electrical circuit component (not shown) that has been inserted into the guide channel 30. The illustrated battery terminal 28 is located in the guide channel 30, and may optionally protrude from the channel floor 34 as shown.

Once the electrical circuit component has been positioned, the electrical circuit component may be mechanically fixed to the battery terminal 28 using a terminal fastener 40 according to an aspect of the disclosure, and defined further below.

In the example of FIG. 3, the battery terminal 28 comprises a fastener engaging portion 28a for engaging a terminal fastener, and a bearing portion 28b (e.g. plate) against which the terminal fastener may compress the electrical circuit component. As illustrated, the bearing portion 28b may at least partially surround the fastener engaging portion 28a of the battery terminal 28.

In use, electrical current may flow to/from the electrical circuit component via one or both of the fastener engaging portion 28a or the bearing portion 28b. Consequently, one or both of the fastener engaging portion 28a or the bearing portion 28b comprises electrically conductive material.

The bearing portion 28b, if provided, may be slightly raised relative to the channel floor 34. Alternatively, the bearing portion 28b may be flush or omitted entirely, and the electrical circuit component may be compressed against the channel floor 34 or another part of the end cap 26/cell module 22.

During assembly of the cell module 22, the states of charge of the individual battery cells 24 may only be partially-depleted and not fully-depleted, for durability reasons. The partial charge may result in a terminal voltage in the tens of volts.

It is challenging to make a traction battery 14 easy and fast to assemble, to provide strong electrical and mechanical connections, but with a good degree of touch-proofing during (and after) assembly.

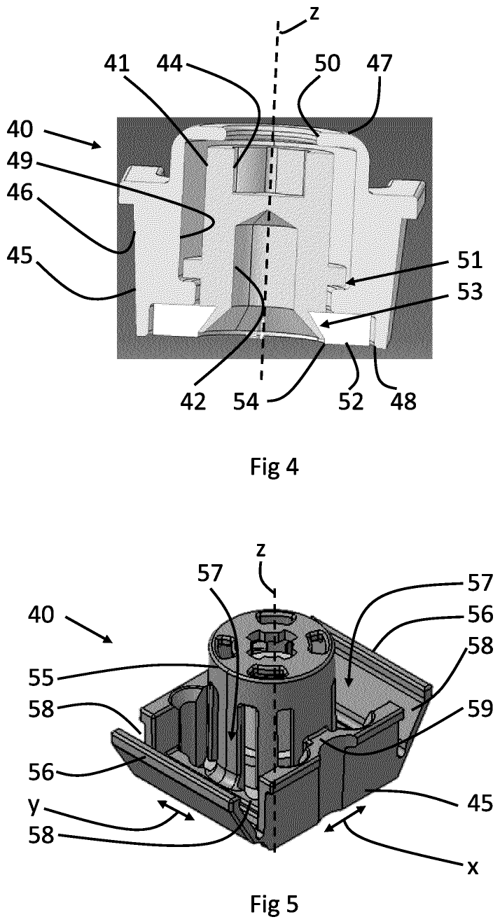

FIG. 4 illustrates an example of a terminal fastener 40 according to an aspect of the disclosure. The terminal fastener 40 reduces/avoids touching of electrically conductive materials during assembly.

The terminal fastener 40 is usable with a battery terminal 28 implemented according to any one of the examples described herein, not limited to the examples shown in FIG. 2 or 3.

The terminal fastener 40 comprises at least: a terminal engaging portion 42; a tool receiving portion 44; insulation 45; and may comprise any one or more of the optional additional features described and illustrated herein.

The terminal engaging portion 42 is configured to engage with the battery terminal 28. The engagement is direct and fixes the terminal engaging portion 42 to the battery terminal 28. The engagement may be via interlocking. For example, the terminal engaging portion 42 and the battery terminal 28 may comprise interlocking threads (not shown) or some other means.

If the battery terminal 28 comprises a male fastener engaging portion 28a (plug) as shown in FIGS. 2-3, the terminal engaging portion 42 may be female (socket) as shown in FIG. 4. The fastener engaging portion 28a may be threaded. Alternatively, if the battery terminal 28 is female (socket), the terminal engaging portion 42 may be male (plug).

The tool receiving portion 44 is configured to receive a tool (not shown) to enable fastening of the terminal engaging portion 42 to the battery terminal 28 by force applied to the tool. Therefore, fastening can be performed with the assembler's hands placed at a greater distance from the battery terminal 28. The tool receiving portion 44 may be female (socket) as shown, or male (plug).

An example of a female socket-type tool receiving portion 44 comprises an internal hole such as an internal polygonal hole. The illustrated internal polygonal hole is a hexagonal hole compatible with a Hex-headed tool such as an Allen key. Another example of an internal hole is a slotted arrangement such as a single slot or cross-shaped slot.

An example of a male plug-type tool receiving portion 44 comprises an external polygon. However, an internal hole is more useful than an external polygon for minimizing the amount of exposed uninsulated surface required for tool access.

Fastening the terminal fastener 40 may comprise engaging a tool with the tool receiving portion 44, and using the tool, by applying force, to fasten the terminal engaging portion 42 to the terminal fastener 40.

If the terminal engagement is enabled by interlocking threads, the fastening may comprise rotating the tool about a centre z-axis (height axis) shown in FIG. 4. The centre z-axis passes through the centre of the tool receiving portion 44, and may define the axis of rotation of the tool.

In some, but not necessarily all examples, the tool receiving portion 44 and the terminal engaging portion 42 may be fixed to each other and therefore unable to move relative to each other. The illustrated terminal fastener 40 carries both the tool receiving portion 44 and the terminal engaging portion 42 on a single connector body 41.

The connector body 41 may be manufactured as a single integral piece of material formed or cast of one piece. Alternatively, separate pieces may be fixed together.

The illustrated tool receiving portion 44 is coaxial with the terminal engaging portion 42. Therefore, the tool receiving portion 44 is coaxial with the battery terminal 28 when in use and assembled.

If the terminal engaging portion 42 is threaded, the centre z-axis may also be the thread axis of the terminal engaging portion 42.

The illustrated tool receiving portion 44 and terminal engaging portion 42 are at opposite faces of the illustrated connector body 41.

The above-described arrangement of the connector body 41 makes the terminal fastener 40 rigid and unlikely to move in unintended directions as force applied to the tool increases. However, it would be appreciated that in other examples, the tool receiving portion 44 could be remotely coupled to the terminal engaging portion 42 via other means such as a mechanism.

The illustrated connector body 41 is cylindrical and axisymmetric about the centre z-axis. In other examples, the connector body 41 may be another shape.

The connector body 41 may comprise electrically conductive material such as ferrous metal, copper, aluminum, or the like. Ferrous metal such as steel provides a better combination of mechanical strength and electrical conductivity.

By making components of the terminal engaging portion 42 (or more) electrically conductive, the terminal fastener 40 may be configured to close an electrical connection between the battery terminal 28 and the electrical circuit 12.

To facilitate this electrical connection, the illustrated terminal fastener 40 comprises an interface component 52, such as a washer, configured to electrically couple the terminal engaging portion 42 to a component of the electrical circuit 12 of the vehicle 1, such as a busbar.

The interface component 52 is electrically coupled to the terminal engaging portion 42, for example via the electrically conductive material of the connector body 41.

The interface component 52 may define an exposed external surface of the terminal fastener 40, not covered by insulation 45. The exposed surface may provide an electrical interface.

The exposed surface may comprise electrically conductive material, such as one of the earlier-described example electrically conductive materials.

In the illustration, the exposed surface is adjacent to or at the same surface of the connector body 41 as the terminal engaging portion 42, to face away from an assembler during assembly.

The use of an exposed surface at the illustrated location enables terminal fastening and electrical connection to be performed in a single assembly step. If a portion of the electrical circuit component (e.g. busbar) is placed between the terminal engaging portion 42 and the cell module 22/end cap 26/guide channel 30/bearing portion 28b, then fastening of the terminal engaging portion 42 to the battery terminal 28 may compress the exposed surface against the electrical circuit component to cause the mechanical and electrical connection between the interface component 52 and the electrical circuit component.

The exposed surface of the interface component 52 may be slightly raised or proud relative to the adjacent surface of the connector body 41 and/or insulation 45, to ensure proper compression and electrical engagement, and to direct the force path through the interface component 52.

The interface component 52 does not have to comprise an external exposed surface as shown and may alternatively be a plug or socket that is independently engageable or disengageable, at the cost of an extra assembly step.

The illustrated interface component 52 is a washer or other component that comprises an inner aperture 54. The washer may be a spring washer or plain washer, or other type.

The inner aperture 54 of the interface component 52 is for enabling the terminal engaging portion 42 and at least a portion (e.g. 28a) of the battery terminal 28 to access each other, by passing through the inner aperture 54.

The inner aperture 54 may have a larger nominal dimension (e.g. circle diameter) than the nominal dimension of the battery terminal 28 and/or the nominal dimension of the terminal engaging portion 42.

The interface component 52 may be a captive component of the terminal fastener 40, so that the interface component 52 may be another body inseparable from the connector body 41 and/or inseparable from the insulation 45. This means that the interface component 52 and the connector body 41 do not need to be held in position during positioning and fastening.

Captive means that the interface component 52 cannot be easily removed, for example there is no threaded connection between the interface component 52 and the connector body 41. The terminal fastener 40 is therefore supplied with a captive interface component 52 and no pre-assembly is required.

FIG. 4 shows an example of a first capture arrangement 53 which captures the interface component 52 to the connector body 41. The first capture arrangement 53 comprises formations on the interface component 52 and on the connector body 41 (or on the insulation 45 in other examples) that are configured to interfere.

In the illustration, a lower portion the connector body 41 is wider than an upper portion of the inner aperture 54 of the interface component 52, to provide the formation, wherein upper means towards the tool receiving portion 44. This formation may be achieved by splaying the connector body 41 and/or by narrowing the inner aperture 54, or by a combination of both as illustrated.

The interface component 52 as described is a separate body of material from the connector body 41. However, in other examples, the interface component 52 could alternatively be a continuous/integral portion of a same body that comprises the terminal engaging portion 42, such as the connector body 41.

As a still further alternative, the interface component 52 could be omitted from the terminal fastener 40 entirely. The electrical connection may instead be between the surface (e.g. bearing portion 28b) on the end cap 26/cell module 22 against which the electrical circuit component is compressed.

The above-described terminal fastener 40 of FIG. 4 or other examples comprises electrically conductive material at: the terminal engaging portion 42; the tool receiving portion 44; and at the exposed surface of the optional interface component 52.

The portions/components are electrically coupled to each other, and may all become electrically charged when electrical contact is made with the battery terminal 28.

The function of the provided insulation 45 is therefore to touch-proof the terminal engaging portion 42 and tool receiving portion 44 (and optional interface component 52), by the required extent. This helps to avoid transfer of electric charge to the assembler's body. The insulation 45 will be defined in more detail.

The insulation 45 comprises electrically insulating material. The electrically insulating material may comprise a polymeric material or another insulating material. The polymeric material may comprise polypropylene or any other suitable polymeric material. In some examples, the insulation 45 may be configured to provide a dielectric strength of one kilovolt or greater and/or to provide a Comparative Tracking Index of 175 or greater.

In some, but not necessarily all examples, the insulation 45 may be formed as a block of material. A block of material refers to a non-fabric material, such as a moulded material.

The material of the insulation 45 may be resilient material causing the whole block or a substantial portion thereof to be a resilient block of material. Whether flexible or not, a resilient block of material returns to its original shape when an externally-applied force (within an elastic limit) is removed, such as bending or twisting force. The block may therefore be resilient and retain its shape against applied force. The block may be a moulded block, formed by techniques such as moulding.

The insulation 45 may comprise a first aperture 48 for at least the terminal engaging portion 42, a second aperture 50 for the tool receiving portion 44, and a side wall 46 extending between the first aperture 48 and the second aperture 50 and interconnecting the first and second apertures 48, 50.

The first aperture 48 is dimensioned to enable interconnection of the battery terminal 28 with the terminal engaging portion 42 through the first aperture 48. The second aperture 50 is dimensioned to enable engagement of the tool with the tool receiving portion 44 through the second aperture 50.

The nominal dimension of the second aperture 50 may be a value less than a touch-proofing limit. In the illustration, the second aperture 50 is circular and the nominal dimension is its diameter. In other examples the second aperture 50 may be non-circular, such as a cruciform shape. More generally, the nominal dimension may be defined as the diameter of the largest circle that can be drawn within the second aperture 50 that is within the perimeter of the second aperture 50.

The touch-proofing limit may be a value from the range approximately 5 mm to approximately 20 mm. The touch-proofing limit may be less than 12.5 mm which the Ingress Protection Marking code, IP2X, designates as the reference dimension of a finger. The nominal dimension may be IP2X compliant according to the test method defined in standards such as BS EN 61032:1998.

A touch-proofing limit less than 10 mm helps to account for compressibility of a finger pushed into the second aperture 50.

The nominal dimension of the second aperture 50 is however large enough to enable insertion of the required tool. The nominal dimension of the second aperture 50 is greater than a nominal dimension of the tool receiving portion 44 that designates the tool size to be used.

The first aperture 48 in the insulation 45 may be larger than the second aperture 50, for example by having a larger average diameter. In FIG. 4, the first aperture 48 exposes not only the terminal engaging portion 42, but also the external exposed surface of the interface component 52.

The first and second apertures 48, 50 do not necessarily have to be the only gaps in continuous insulation 45. In some examples, the insulation 45 may comprise one or more discontinuities (not shown) exposing electrically conductive material.

The discontinuities may comprise gaps exposing the electrically conductive material of the connector body 41. The nominal dimensions of the discontinuities may be no larger than the touch-proofing limit.

The discontinuities may be for making manufacturing easier (e.g. moulding), for weight reduction, and/or for enabling test probe access for electrical testing of battery voltage, battery resistance, or other characteristics.

A discontinuity in the side wall 46 enables improved test probe access from a different angle while the traction battery 14 is in-situ on a vehicle 1, in case the tool receiving portion 44 is obstructed. A plurality of discontinuities around the circumference of the side wall 46 enables omnidirectional test probe access.

As illustrated, the side wall 46 of the insulation 45 may comprise an internal cavity 49 comprising the connector body 41. The cavity 49 is a hollow.

As illustrated, the insulation 45 may comprise an enclosure 47. The insulation 45 is directed inwards towards the centre z-axis to form the enclosure 47. The enclosure 47 partially covers a face of the connector body 41. The illustrated cavity 49 is defined by the side wall 46 and the enclosure 47.

As illustrated, the enclosure 47 may comprise the second aperture 50 for the tool receiving portion 44, so that the second aperture 50 is smaller than the first aperture 48 for touch-proofing.

In FIG. 4, but not necessarily in all examples, the illustrated insulation 45 comprises an enclosure 47 at one end but not both ends, so that the first aperture 48 has a larger dimension/diameter than the second aperture 50.

The insulation 45 may be a captive component of the terminal fastener 40, so that the insulation 45 may be another body inseparable from the connector body 41 and/or inseparable from the interface component 52. This means that the insulation 45 and the connector body 41 do not need to be manually held in position during fastening.

Captive means that the insulation 45 cannot be removed, for example there is no threaded connection between the insulation 45 and the connector body 41. The terminal fastener 40 is therefore supplied with captive insulation 45 and no assembly is required.

FIG. 4 shows an example of a second capture arrangement 51 which captures the insulation 45 to the connector body 41 in at least one direction.

In FIG. 4, the second capture arrangement 51 inhibits removal of the insulation 45 from the connector body 41 in a first direction, and the enclosure 47 inhibits removal of the insulation 45 from the connector body 41 in a second direction opposite the first direction.

Therefore, the enclosure 47 may be functionally regarded as part of the second capture arrangement 51 that provides the added benefit of touch-proofing.

The illustrated second capture arrangement 51 comprises formations on the insulation 45 and on the connector body 41 (or on the interface component 52 in other examples) that are configured to interfere.

The formations may comprise a flange extending away from the connector body 41 and a flange extending into the cavity 49 from the insulation 45, as illustrated.

With particular reference now to FIG. 5, the insulation 45 does not necessarily have to be axisymmetric about the centre z-axis. The insulation 45 may be axi-asymmetric and therefore non-circular, which FIG. 5 shows in more detail. The axi-asymmetric geometry may enable further improvements in touch-proofing, as described below.

When viewed in plan from a vantage point on the centre axis, the illustrated insulation 45 is elongated in a lateral x-axis (length axis) direction that is perpendicular to the centre axis. FIG. 5 is one of various example implementations of elongated insulation 45. The insulation 45 may be elongated into a rectangular or obloid (between rectangular and circular) silhouette in plan-view as illustrated, or could be another shape with three or more vertices.

The function of the elongation is to cover an uninsulated end region of the busbar/electrical circuit component extending away from the centre axis, that would otherwise be electrically exposed.

This is useful when busbars/electrical circuit components that comprise uninsulated end regions are used. Uninsulated end regions enable electrical interconnection with the battery terminal 28 and/or the interface component 52 of the terminal fastener 40, but may have a large area.

The elongation is in an x-axis direction substantially parallel to the direction that the busbar/electrical circuit component (not shown) extends from beneath the terminal fastener 40. The elongated insulation 45 is longer in the lateral x-axis (length) than in a lateral y-axis.

When fastened to the cell module 22 of FIG. 3, the elongation direction may be substantially parallel to the guide channel 30 of the cell module 22, parallel to the channel walls 32, 36.

FIG. 5 shows insulation 45 comprising an optional centre section 55 comprising the side wall 46 and enclosure 47 that enclose the connector body 41 in the cavity 49. As illustrated, the centre section 55 may be axisymmetric. As illustrated, the centre section 55 may be cylindrical.

The insulation 45 of FIG. 5 further comprises an optional axi-asymmetric portion 59 extending laterally away from the centre section 55 to provide the elongated rectangular (or other) shape.

With reference to FIG. 5, the axi-asymmetric portion 59 of the insulation 45 may comprise one or more optional cavities 57. The cavities 57 may be open at one face (as shown), or more faces, or may be closed cavities.

In the example of FIG. 5, the walls of the illustrated cavities 57 comprise an exterior surface of the centre section 55 of the insulation 45, specifically the side wall 46 in FIG. 5, and an interior surface of the axi-asymmetric portion 59.

The cavities 57 are shown to either side of the centre section 55.

In FIG. 5, the shapes of a pair of cavities 57 to either side of the centre section 55 cause the axi-symmetric portion bounding the cavities 57 to define an H-shape in the plan-view, analogous to a y-axis web interconnecting a pair of x-axis flanges. The illustrated centre section 55 of the insulation 45 is connected to the web.

As shown in FIG. 5, the insulation 45 may comprise flexible portions 56. The flexible portions 56 may be resiliently flexible, or plastically flexible if not reusable. The flexible portions 56 can be flexed out of a neutral shape if a busbar/electrical circuit component needs to turn a sharp corner, an example of which is shown within a circle in FIG. 7. Therefore, the flexible portions 56 reduce packaging complexity.

The flexible portions 56 are at lateral end regions (e.g. lateral end faces) of the insulation 45. The lateral end regions are at opposite ends of the axi-asymmetric portion 59, for example opposite faces in the elongated x-axis.

When fastened to the cell module 22 of FIG. 3, the flexible portions 56 extend in a y-axis (width axis) across the space between the first channel wall 32 and the second channel wall 36.

Within the frame of reference of the terminal fastener 40 itself, the flexible portions 56 may extend at least partially in a first lateral direction shown as the x-axis (longest, elongated axis), and may extend in a second lateral direction shown as the y-axis (shortest, non-elongated axis), and in FIG. 5 but not necessarily in all examples they also extend in a third direction shown as the z-axis (centre axis/height axis).

Flexing of a flexible portion 56 by a busbar in use may push the flexible portion 56 towards the centre (z-axis) and/or reduces the extension of the flexible portion 56 in the x-axis. The flexible portions 56 may flex into the cavities 57.

Flexible portions 56 may be formed by removing material to form cutouts, as shown, or by thinning or changing materials.

In FIG. 5, the removal of material comprises providing cutouts. The cutouts of FIG. 5 are laterally spaced slits 58 (spaced in y-axis). The slits 58 may be open at one end as shown, or closed at both ends. A slit 58 is longer than it is wide. A flexible portion 56 as illustrated is the material between a pair of slits 58.

A slit 58 in the insulation 45 may be empty of material or may comprise a stretchable/flexible material. Cutouts could have a different shape in other examples, such as perforations.

In FIG. 5, but not necessarily in all examples, the flexible portions 56 in their neutral unflexed states are inclined upwards (z-axis, towards the tool receiving portion 44) relative to the x-y plane with some extension in the x-axis (non-vertical). The illustrated flexible portions 56 and other lateral walls of the axi-asymmetric portion 59 give the axi-asymmetric portion 59 the external appearance of a trapezoid when viewed from the y-axis.

The trapezoid is an example of various external shapes (including curved shapes) of the insulation 45 that reduce in width (x-axis length and/or y-axis length) with decreasing z-axis distance from the terminal engaging portion 42. By making the insulation 45 wider in the x and/or y axes at greater z-axis heights, the busbar/electrical circuit component can turn a tighter radius (circled area in FIG. 7) while improving touch-proofing. This shape in combination with the flexible portions 56 can simplify packaging even further.

At least the axi-asymmetric portion 59 of the insulation 45 (or the whole of the insulation 45 as shown) may have freedom of rotation relative to at least the terminal engaging portion 42. The freedom of rotation may be about the centre z-axis (e.g. thread axis).

This freedom of rotation enables the elongated insulation 45 to be longer in the x-axis than the separation of the guide walls of the guide channel 30 shown in FIG. 3, without interference during fastening.

Referring to FIGS. 4-5, the insulation 45 may have freedom of rotation relative to the connector body 41. The first capture arrangement 53 is unthreaded and enables the relative rotation between the insulation 45 and the connector body 41, in the x-axis (e.g. thread axis).

If the interface component 52 is provided as a separate body, the interface component 52 may have freedom of rotation relative to at least the terminal engaging portion 42. The freedom of rotation may be about the centre z-axis (e.g. thread axis). In FIG. 4, the interface component 52 has freedom of rotation relative to the connector body 41 and may have freedom of rotation relative to the insulation 45. This helps to protect the softer material of the busbar/electrical circuit component and keeps the busbar/electrical circuit component aligned during fastening.

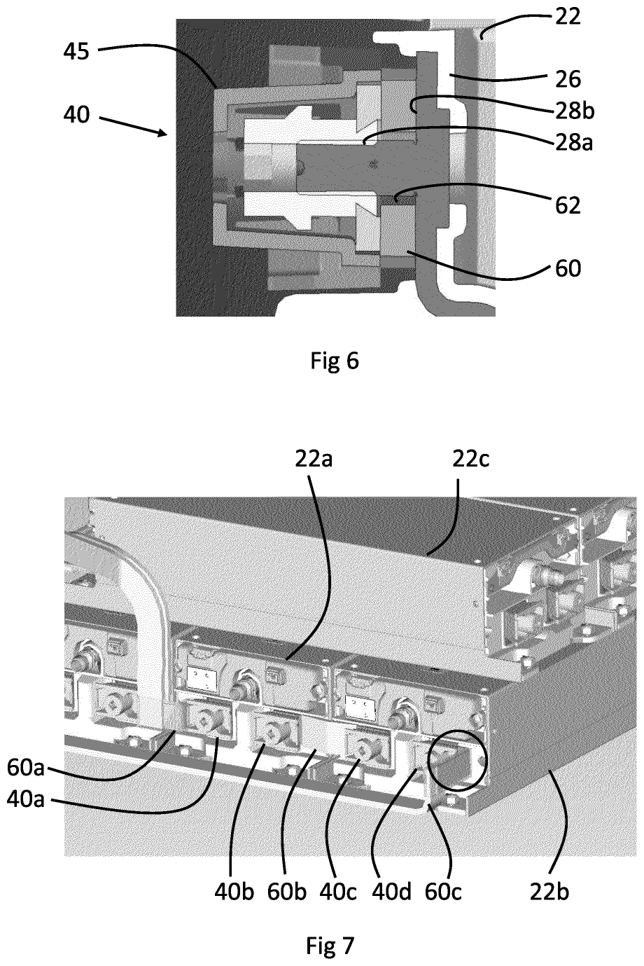

FIG. 6 shows how a terminal fastener 40 according to various examples may be fastened to the battery terminal 28, wherein the electrical circuit component is a busbar 60. A busbar 60 is generally a rigid and inflexible solid body of material, and not stranded. Busbars may have rectangular cross-sections or other obloid shapes that present a substantially flat engagement surface. FIG. 9 outlines the method 90 of manufacture.

The busbar 60 may first be positioned against a battery terminal 28 (block 92). In the implementation of FIG. 6, the busbar 60 is positioned against the bearing portion 28b of the battery terminal 28. The busbar 60 may comprise an aperture 62 dimensioned to enable the male fastener engaging portion 28a of the battery terminal 28 to extend therethrough. In the illustrated example, the positioning of the busbar 60 comprises engaging the aperture 62 with the battery terminal 28 so that at least a portion (28a) of the battery terminal 28 extends through the aperture 62.

Then, the terminal fastener 40 may be positioned against the busbar 60 (block 94), with the terminal engaging portion 42 and optional interface component 52 facing the busbar 60 and battery terminal 28, and the tool receiving portion 44 facing away from the busbar 60 and battery terminal 28. At this stage, the only electrically conductive part of the terminal fastener 40 that is facing an assembler is the tool receiving portion 44 touch-proofed by the second aperture 50 of the insulation 45.

The terminal engaging portion 42 is engaged with the battery terminal 28 (block 96), by hand or using a tool engaged with the tool receiving portion 44 of the terminal fastener 40 (block 98). The tool may be engaged before or after block 96 of the method 90. The tool may comprise an insulated handle. In FIG. 6, the engagement is between the terminal engaging portion 42 of the terminal fastener 40 and the fastener engaging portion 28a of the battery terminal 28.

Then, the assembler may use the tool to fasten the terminal engaging portion 42 of the terminal fastener 40 to the battery terminal 28 (block 100), for example by rotating a portion of the tool engaged in the tool receiving portion 44 about the z-axis to engage threads.

The fastening causes the terminal fastener 40 to compress the busbar 60. The busbar 60 is compressed against electrically conductive material (the interface component 52 of the terminal fastener 40 and/or the bearing portion 28b of the battery terminal 28), to form an electrical connection between the traction battery 14 and the busbar 60.

Electrically conductive material according to an example is provided on both the bearing portion 28b of the battery terminal 28, and the interface component 52 of the terminal fastener 40. Therefore, the busbar 60 is electrically connected from both sides to improve the connection, and the electrical connection is robust due to compression of the busbar 60 between the cell module 22 (e.g. channel floor 34) and the interface component 52 (e.g. washer).

However, it would be appreciated that in other examples, the interface component 52 could be omitted and the electrically conductive material could be on the cell module 22. The electrically conductive material may be on the bearing surface 28b of the battery terminal 28, and the terminal fastener 40 may carry no electrical charge. Resistive losses may be higher, however.

The electrical connection is only created after the terminal fastener 40 has been correctly engaged (e.g. threaded) and tightened by a required amount so that the terminal fastener 40 is not likely to fall/move out of position.

Disassembly for maintenance can be performed by engaging a tool with the tool receiving portion 44 of an engaged terminal fastener 40, and rotating the tool in a disengaging direction to disengage threads.

FIG. 7 shows a plurality of terminal fasteners 40a-40e connecting busbars 60a-60d to a plurality of cell modules 22a-c. The voltage across the terminal of a single cell module (fully charged) may be from the range 20 Volts to 100 Volts or more.

A first terminal fastener 40a connects a first busbar 60a to a first polarity terminal of a first cell module 22a.

A second busbar 60b is connected at one end region to a second polarity terminal of the first cell module 22a by a second terminal fastener 40b. The second busbar 60b is connected at the other end region to a second polarity terminal of a second cell module 22b by a third terminal fastener 40c.

A third busbar 60c is connected to a first polarity terminal of the second cell module 22b by a fourth terminal fastener 40d.

Cell modules may be stacked in layers. A third cell module 22c is shown on a second upper layer above the first and second cell modules 22a, 22b, extending in a different (e.g. perpendicular) direction. The first and third busbars 60a, 60c may extend between layers. The busbars are electrically coupled to electrical outputs/terminals of the whole traction battery 14.

The modular construction of FIG. 7 enables a variety of traction battery shapes to be designed for a vehicle 1. This improves packaging of traction batteries within vehicles. The busbars may need to bend in various three-dimensional directions, and the terminal fastener according to various examples described herein enables tighter bend radii, see for example the circled region in FIG. 7.

The use of individual terminal fasteners 40 for individual battery terminals 28, rather than a strip of fasteners for a group of battery terminals, enables a greater variety of traction battery shapes to be designed for a vehicle.

The overall z-axis height of a terminal fastener may be less than approximately 3 cm, to provide a low profile and improve packaging.

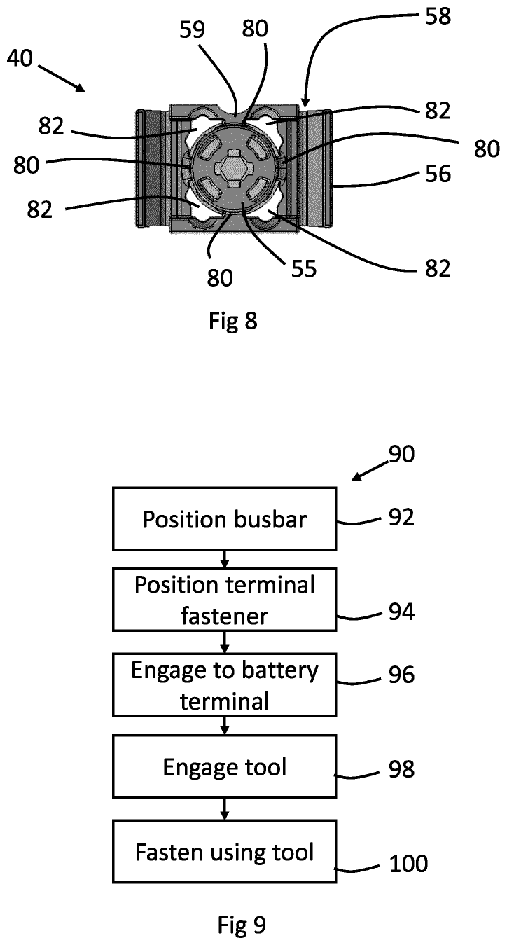

FIG. 8 illustrates a top view of a terminal fastener 40 according to various examples. The axi-asymmetric portion 59 comprises base apertures 80. The base apertures 80 are at the base of the axi-asymmetric portion 59 closest to the interface component 52 (not visible). Therefore, the cavities 57 may be regarded as through-holes open at either end. The base apertures 80 are separated from each other by base linking portions 82. The base linking portions 82 interconnect the centre section 55 to the walls of the axi-asymmetric portion 59.

It will be appreciated that various changes and modifications can be made to the present disclosure without departing from the scope of the present application.

As used here ‘module’ refers to a unit or apparatus that excludes certain parts/components that would be added by an end manufacturer or a user.

Although embodiments of the present disclosure have been described in the preceding paragraphs with reference to various examples, it should be appreciated that modifications to the examples given can be made without departing from the scope of the disclosure as claimed. For example, a wire could be used instead of a busbar.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

1. A terminal fastener for electrically connecting a battery terminal associated with at least part of a traction battery to an electrical circuit of a vehicle, the terminal fastener comprising:
a terminal engaging portion configured to engage with the battery terminal;
a tool receiving portion configured to receive a tool to fasten the terminal engaging portion to the battery terminal; and
insulation configured to cover at least part of the terminal fastener;
wherein the insulation comprises a first aperture for at least the terminal engaging portion and comprises a second aperture through which the tool is insertable for engaging with the tool receiving portion, wherein a nominal dimension of the second aperture is less than 12.5 millimeters.

2. (canceled)

3. The terminal fastener of claim 1, wherein the insulation has freedom of rotation relative to at least the terminal engaging portion.

4. The terminal fastener of claim 1, wherein the insulation is a captive component of the terminal fastener.

5. The terminal fastener of claim 1, wherein the terminal engaging portion and the tool receiving portion are fixed to each other.

6. The terminal fastener of claim 1, wherein the tool receiving portion comprises electrically conductive material, wherein the terminal engaging portion comprises electrically conductive material, and wherein the tool receiving portion is electrically coupled to the terminal engaging portion.

7. The terminal fastener of claim 1, further comprising an interface component configured to mechanically interface with a component of the electrical circuit of the vehicle.

8. The terminal fastener of claim 7, wherein the interface component is configured to electrically couple the terminal engaging portion to the component of the electrical circuit of the vehicle.

9. The terminal fastener of claim 8, wherein the interface component comprises a washer.

10. The terminal fastener of claim 8, wherein the interface component has freedom of rotation relative to at least the terminal engaging portion.

11. The terminal fastener of claim 8, wherein the interface component is a captive component of the terminal fastener.

12. The terminal fastener of claim 8, wherein the interface component comprises an aperture for enabling the terminal engaging portion and the battery terminal to access each other.

13. The terminal fastener of claim 1, wherein a width of the insulation decreases with decreasing distance from the terminal engaging portion.

14. The terminal fastener of claim 1, wherein at least a portion of an exterior surface of the insulation is flexible.

15. The terminal fastener of claim 1, wherein the terminal engaging portion is threaded.

16. A system comprising the terminal fastener of claim 1, and a cell module, wherein the cell module is configured to house a plurality of battery cells, and comprises the battery terminal.

17. The system of claim 16, further comprising a busbar, wherein the terminal fastener is configured to electrically connect the battery terminal to the electrical circuit of the vehicle by mechanically fixing and electrically connecting the busbar to at least a portion of the battery terminal.

18. The system of claim 17, wherein the terminal fastener is configured to compress the busbar against the battery terminal to form an electrical connection.

19. The system of claim 17, wherein the busbar comprises an aperture to facilitate fixing of the busbar in position by engagement of the terminal engaging portion with the battery terminal.

20. The system of claim 17, further comprising the plurality of battery cells housed by the cell module.

21. A traction battery comprising a plurality of cell modules and one or more busbars as claimed in claim 17, wherein the cell modules are electrically interconnected by the one or more busbars.

22. A vehicle comprising the traction battery of claim 21.

23. A method of manufacture of the traction battery of the vehicle, using the terminal fastener as claimed in claim 1, the method comprising:
positioning a busbar against the battery terminal associated with at least part of the traction battery;
positioning the terminal fastener against the busbar;
engaging the terminal engaging portion of the terminal fastener with the battery terminal, with the busbar therebetween;
engaging the tool with the tool receiving portion of the terminal fastener; and
using the tool to fasten the terminal engaging portion of the terminal fastener to the battery terminal, causing the terminal fastener to compress the busbar against electrically conductive material to form an electrical connection.

24. The terminal fastener of claim 1, wherein the insulation comprises a side wall extending between the first aperture and the second aperture and interconnecting the first and second apertures.
